(19) United States
(12) Patent Application Publication
(10) Pub. No.: US 2011/0243877 A1
(43) Pub. Date: Oct. 6, 2011

(54) Embalming composition and method

(76) Inventor: Adrian Featherstone, Hamilton (NZ)

(21) Appl. No.: 12/931,049

(22) Filed: Jan. 21, 2011

Related U.S. Application Data
(60) Provisional application No. 61/336,579, filed on Jan. 22, 2010.

(51) Int. Cl. A01N 1/00

(52) U.S. Cl. 424/75

(57) ABSTRACT

A method of retarding the decomposition of human remains comprises embalming the remains with an aqueous solution of chlorine dioxide.

This application claims priority based on U.S. Provisional Patent Application filed Jan. 21, 2010 as Ser. No. 61/336,579.

According to a new study published online Nov. 20, 2009 in the Journal of the National Cancer Institute, “Funeral Industry Workers Exposed to Formaldehyde Face Higher Risk of Leukemia, Science Daily” (Nov. 23, 2009): “Long durations of exposure to formaldehyde used for embalming in the funeral industry were associated with an increased risk of death from myeloid leukemia. Previous studies have shown excess mortality from lymphohematopoietic malignancies and brain cancer in anatomists, pathologists, and funeral industry workers, all of whom may have worked with formaldehyde”.

I have discovered a new embalming fluid composition. The composition inhibits the rate of decomposition of human remains. The fluid is organically certified, offers funeral homes a solution to the environmental concerns expressed by the public, and provides a safer working environment for professionals employed in the industry. The composition can be used at various dilutions and percentages as an arterial or cavity fluid. It is extremely safe to use and has minimal impact on the environment. It produces a very natural feet and colour to the skin. It enables the embalming of infectious cases generally not recommended for embalming. It is cost effective and does not require any special storage or transport requirements. It does not require any co-injection fluids. It can also be used as a topical and hard surface sanitiser.

The fluid composition is a biodegradable solution formulated to effectively inhibit decomposition for up to 5 days. The fluid composition comprises of Chlorine Dioxide in Aqueous Solution. If desired a dialdehyde can be utilized in the aqueous chlorine dioxide embalming solution to inhibit the rate of decomposition beyond five days. Chlorine Dioxide in Aqueous Solution is a very effective potent broad spectrum antimicrobial sanitiser which inhibits the decomposing process of human remains. When the solution comes into contact with bacteria, the bacteria are destroyed and the Chlorine Dioxide in Aqueous Solution is exhausted and converts to Sodium Chlorite. Any remaining Chlorine Dioxide in Aqueous Solution lies in wait for any new bacterial re-growth. When the entire amount of Chlorine Dioxide in Aqueous Solution is exhausted the bacteria proliferate to a level where the natural decomposition process recommences unimpeded The amount of Chlorine Dioxide in Aqueous Solution ordinarily utilized in the solution falls well within the REL limit of 0.1%. In particular, the aqueous embalming solution includes 100 ppm to 1500 ppm chlorine dioxide, preferably 125 ppm to 1000 ppm chlorine dioxide, most preferably 125 ppm to 500 ppm chlorine dioxide. The aqueous chlorine dioxide embalming solution can also, if desired, include a stabilizer to extend the shelf life of the solution. ERMA New Zealand Approval Code HSR007938 has determined the hazard classification for Chlorine Dioxide in Aqueous Solution as aquatic ecotoxicity 9.1D with no discernible ecosystem impact and no toxic properties that are risk to human health. The Chlorine Dioxide in Aqueous Solution of the invention is a non-toxic biodegradable solution that leaves a residue equivalent to half a teaspoon of Sodium Chloride. It enables the natural putrefaction process to continue soon after interment of the body. The body looks very natural in colour and feels soft to touch. There is minimal chemical odour. There is no firming of the tissue or rigidity of the joints. The most obvious indicators of distribution and diffusion of fluid are dilatation of the superficial blood vessels, removal of postmortem discolorations, rounding of the fingertips and a generalised plumping of the tissues. The santising solution destroys 99.999% of the microbial population on contact. To achieve optimum results, it is crucial that the body tissues are completely diffused with the Chlorine Dioxide in Aqueous Solution. To ensure diffusion of the deep tissues, use intermittent drainage after the initial injection into an open drainage circuit. It is recommended that the user guidelines be carefully followed to achieve optimum results. This fluid must not be mixed with any other brands of embalming chemicals.

The Chlorine Dioxide in Aqueous Solution does not produce the same texture and feel to the skin as experienced with formaldehyde based fluids. There is no firming or noticeable change in texture of the skin. The embalming results present a natural colour and skin texture. The limbs remain flaccid, making dressing of the body easier which is so important when family members are performing this task.

A total solution of 12 litres is recommended for a 100 kg body. The may sound excessive in comparison to normal practice. However, the amount of fluid required is relative to the size and condition of the body. There must be enough active Chlorine Dioxide in Aqueous Solution injected and remaining in the body tissues to inhibit any microbial activity on contact. The other factor to consider is the length of time the body is required to be kept and remember that over a period of five days, under normal circumstances, the continual regrowth of bacteria will exhaust any remaining santiser and finally continue the decomposition process uninhibited. This 5 day period can be extended to 21 days if 40% Glyoxal and 20% Sodium Acetate Buffer Solution is added to the aqueous chlorine dioxide solution. When used with 40% Glyoxal solution and a 20% Sodium Acetate Buffer Solution, the tissues are likely to firm slightly. The Glyoxal is, as noted, an aqueous solution containing 40% by weight by Glyoxal. 250 ml to 750 ml, preferably 350 ml to 650 ml, and most preferably 450 ml to 550 ml of the 40% Glyoxal solution is added to every twelve liters of embalming solution. The buffer solution is an aqueous solution including 20% by weight of sodium acetate. One hundred and fifty to 550 ml, preferably 200 ml to 450 ml, most preferably 250 ml to 400 ml of the 20% buffer solution is added to each twelve liters of the aqueous chlorine dioxide embalming solution. If desired, other dialdehydes can be utilized in combination with or in place of Glyoxal, but Glyoxal is presently preferred because it has minimal safety and odor issues. The sodium acetate buffer is not absolutely essential but it produces a more complete preservation reaction. If desired, alternate buffers can be utilized.

Co-injection fluids are not, as noted above, required in combination with the Chlorine Dioxide in Aqueous Solution. Chlorine Dioxide in Aqueous Solution works effectively within a 2-10 pH range, therefore pH buffers are not required. The anti bio film action of the fluid acts like a vascular conditioner and disperses the blood agglutination and intra-vascular obstacles.

When body cavities are aspirated, the mixture of Chlorine Dioxide in Aqueous Solution and 40% Glyoxal and Sodium Acetate Buffer Solution, when added, absorb into the tissues at the rate of 1 mm per hour and the remaining bulk of the solution lies in wait for any bacterial regrowth to destroy on contact. To prevent cavity fluid purge from the body orifices, it is important to avoid perforating the trachea, main bronchus, rectum and vaginal canal when aspirating the cavities.

During the cavity treatment some special procedures are recommended. When preparing the viscera in posted cases dissect the viscera into 15 mm slices to allow for maximum surface for fluid contact. Soak the viscera in a liberal quantity of Chlorine Dioxide in Aqueous Solution and 40% Glyoxal and Sodium Acetate Buffer Solution, when added and rotate frequently for 45-60 minutes. Dry pack the viscera in the body cavity. Place the viscera that have been soaked in cavity fluid, back into the body cavity in thin layers. Sprinkle a generous layer of a mixture of medium and coarse Sodium Chloride granules between each layer of viscera and finish off using normal practice. For non-posted cases, inject 500 mls of the Chlorine Dioxide in Aqueous Solution and 40% Glyoxal and Sodium Acetate Buffer Solution, when added, over the top of the viscera within the thoracic cavities and 1000 mls over the viscera within the abdominal cavity and directly into the spleen and liver. These volumes of cavity fluid can be varied depending upon the circumstances.

Another benefit of the Chlorine Dioxide in Aqueous Solution of the invention is that in jaundice cases are consistently shows a 50-75% reduction in the depth of jaundice discolouration. This is due to the leaching out effect the fluid has on bilirubin. Chlorine Dioxide in Aqueous Solution does not produce any conversion from bilirubin to biliverdin.

The Chlorine Dioxide in Aqueous Solution of the invention can be safely used as a topical spray. For topical spraying use recommended dilution 1:5 of the concentrate solution to water.

In some cases, the deceased may have been refrigerated for 4-5 days before embalming. In this event, the core temperature of the body drops at a rate of 0.8° C. for the first 8 hours and then 0.6° C. each hour until ambient temperature is reached. To arrest the decomposing process directly, the earlier the embalming procedure is performed, the better the result. Taking into account that non-refrigerated tissue will enable optimum distribution and diffusion of fluid, which is the preferred option; delayed embalming under these circumstances will still produce excellent results. The body can be returned to the refrigerator after embalming.

In the event of a limited embalm for the sole purpose of removing postmortem discolouration of the face, a smaller quantity can be used to clear the postmortem discolouration in the face and hands with a shortened period of inhibition of microbial action. This is not recommended for cases held beyond 24 hours, and the ambient temperature and condition of the body must be taken into account at all times.

A mixture of Chlorine Dioxide in Aqueous Solution and 40% Glyoxal and Sodium Acetate Buffer Solution is suitable as an embalming solution used for repatriation to overseas destinations where the temperature during transit and destination does not exceed 40° C.

When used as per manufacturers' recommendation Chlorine Dioxide in Aqueous Solution should retard microbial action for up to 5 days. In temperatures above 30° C. or cases requiring storage beyond this time frame add 180 ml of 40% Glyoxal and Sodium Acetate Buffer Solution to every 4 litres of diluted Chlorine Dioxide in Aqueous Solution and 100 mls per litre of diluted Chlorine Dioxide in Aqueous Solution. It is recommended that these quantities be doubled for every 10° C. above 30° C. ambient temperature. The use of 40% Glyoxal and Sodium Acetate Buffer Solution will extend the retardation period out to 21 days and also make it suitable for most repatriation to overseas destinations where the temperature during transit and destination does not exceed 40° C. 40% Glyoxal and Sodium Acetate Buffer Solution is a dialdehyde, which cross links the protein to denature it so that enzymes cannot work on the protein to degrade/decompose. The autolysis enzyme from the deceased body also cannot work on the protein, because enzymes are protein. The cross-linking action can last for 3 weeks at 20 C., after that bonding will be weaken or degrade so enzymes will be active again.

Chlorine Dioxide in Aqueous Solution, 40% glyoxal and Sodium Acetate Buffer Solution and a mixture of medium and coarse Sodium Chloride granules is suitable for everyday use as well as meeting any environmental issues.

The Chlorine Dioxide in Aqueous Solution of the invention destroys 99.999% of the microbial population including fungi, bacteria and viruses within 60 seconds of contact. Infectious cases such as HepC, TB and AIDs can now be prepared to a safe condition for the families to view and touch without any concern of contamination or risk to personal health. Chlorine Dioxide in Aqueous Solution is listed as a variable or partially effective prion disincentive. Microorganisms cannot build up any resistance against Chlorine Dioxide in Aqueous Solution. Chlorine Dioxide in Aqueous Solution as a disinfectant has the advantage that it directly reacts with the cell wall of microorganisms. This reaction is not dependent on reaction time or concentration. In contrast to non-oxidizing disinfectants, Chlorine Dioxide in Aqueous Solution kills microorganisms even when they are inactive. Chlorine dioxide in its gaseous form is not the same as Chlorine Dioxide in Aqueous Solution. The chemicals are completely different. Chlorine Dioxide in its gaseous, undiluted form is extremely toxic to humans and explosive if not managed properly. Chlorine Dioxide in Aqueous Solution is determined to be safe as previously stated and not explosive. Chlorine dioxide in aqueous solution is not the same as chlorine. Chlorine Dioxide in Aqueous Solution does not bleach the tissue, in the sense of bleaching the skin in the same way a cauterising fluid does, the answer is no. The fluid is a very effective blood solvent and if the superficial tissues receive TOO much fluid, the area is likely to remove the capillary reddish complexion leaving a pale appearance. In extreme cases where there is intense postmortem staining the arterial fluid may product a grey hue in the affected area. There is no significant change in the colour of the skin pigmentation (melanin). To avoid over injection of the fluid to the face and hands, elevate the head or position the hands over the body to restrict the flow of embalming solution to the affected area. Restricted cervical injection is an option if there is any likelihood of over injecting the head. Any pale or greying of the tissues can easily concealed by an application of Crème cosmetics.

At 500 ppm there is a noticeable gas off Chlorine Dioxide in Aqueous Solution which is more obvious in a high humidity environment. To minimise this, always add the solution to water. At less than 500 ppm diluted there is very little, if any, noticeable gas off. At 500 ppm, there is an obvious chlorine-like odour which more obvious in high humidity environment and is less noticeable when diluted.

The Chlorine Dioxide in Aqueous Solution should not be mixed or stored with formaldehyde. Formaldehyde initially turns to formic acid and finally to Carbon Dioxide. There is no risk of explosion. In case of spillage, the chemicals should be stored apart.

The shelf life of the Chlorine Dioxide in Aqueous Solution is 12 months from production when stored away from light, especially UV light, and below 30° C. in the original container tightly sealed when not in use. Any significant loss of colour or odour of the concentrated solution indicates that the fluid is expired and lost its effectiveness and should not be used.

The Chlorine Dioxide in Aqueous Solution will not rust stainless steel instruments. Stainless steel types 304 and 316 are not affected by Chlorine Dioxide in Aqueous Solution when used at the recommended concentration of 15 ppm for a time span of up to 15 minutes.

The Chlorine Dioxide in Aqueous Solution and 40% Glyoxal and Sodium Acetate Buffer Solutions are not likely to damage an embalming machine. As per normal practice, when using any arterial fluid it is essential that the machine is flushed out with a full tank of water at the end of any embalming session.

### PROCEDURES FOR EMBALMING WITH CHLORINE DIOXIDE IN AQUEOUS SOLUTION OF THE INVENTION

The objective of the following procedures is to retard the rate of decomposition of the body for a maximum of 5 days (120 hrs). This is achieved by the injection of the Chlorine Dioxide in Aqueous Solution of the invention, which is a potent broad spectrum antimicrobial agent log 5 contact sanitiser and will achieve 99.999% destruction of bacteria and viruses associated with a deceased within 60 seconds of contact. For optimum results, it is imperative that thorough distribution and diffusion of Chlorine Dioxide in Aqueous Solution is achieved and that it makes contact with all of the body tissues and fluids. In the case analysis, it is important to note the weight of the body and external appearances, significant conditions and disease processes contributing or leading to death. These may differ to the cause of death. The recommended volume is 12 litres of arterial solution for a body weighing 100 kg. The volume of fluid is relative to the size of the body and should be sufficient quantity to fill the body tissues without causing any swelling. When the solution comes into contact with the bacteria, the bacteria are destroyed and the Chlorine Dioxide in Aqueous Solution is exhausted. Any remaining Chlorine Dioxide in Aqueous Solution lies in wait for any new bacteria re-growth. When the entire amount of Chlorine Dioxide in Aqueous Solution is exhausted, the bacteria proliferate to a level where the natural decomposition process recommences unimpeded. The formulation of the Chlorine Dioxide in Aqueous Solution covers a wide range of body conditions and body types. Due to the fact that there is no firming of the tissue, mouth and eye closure can be performed after the arterial injection. Each procedure has been written as a guide to best suit the specific case type. The addition of 40% Glyoxal and 20% Sodium Acetate Buffer Solution can extend the retardation period by at least 21 days.

### Statistics:

Researchers estimate that there is 1-2 kg of bacteria in the living human body. Obviously, the amount and weight of a human's microbial contents will vary, depending upon the size of the human and the sort of diet that has been consumed. The bulk of the bacteria are in the gut lumen, and the rest in the skin, oro-pharynx, and genitalia. In an average healthy adult, the volume of blood is about one-eleventh of the body weight. Most sources state the volume of blood in an average human adult is between 4.7 and 5 litres. However these statistics must be considered as rough guideline only as there are numerous variables to take into account.

The information in the following Tables I to XV is provided by way of example and not limitation. In the below Tables, the maximum concentration of chlorine dioxide used in a particular application is 500 ppm. The concentration of chlorine dioxide can, as noted above, be up to 1500 ppm depending on the application and preferences of those skilled in the art. Similarly, the dilutions and total amount of solution utilized during an embalming procedure can vary as desired.

Recommended fluid dilutions for specific applications:

TABLE I
Solution Mixtures/Proportions

| | Arterial/Cavity | | | | |
|---|---|---|---|---|---|
| | Chlorine Dioxide | | | | |
| | in Aqueous | | | | |
| | Solution 500 ppm | | Cold tap water | | Total solution |
| Case type | (Litres) | | (Litres) | | (Total Litres) |
| Standard | 3 | | 9 | | 12 |
| Renal failure | 5 | | 7 | | 12 |
| Oedema pitted | 8 | | 4 | | 12 |
| Jaundice | 3.5 | | 8.5 | | 12 |
| Decomposed | 5 | | 7 | | 12 |
| Infectious | 5 | | 7 | | 12 |
| Cavity treatment | 1 | | 0 | | 1 |
| Topical sanitiser | 50 | mls | 950 | mls | 1 |
| Instrument sanitiser | 50 | mls | 950 | mls | 1 |

To extend the period of preservation to 21 days add 40% Glyoxal and Sodium Acetate Buffer Solution. (Add 180 ml to every 4 L of arterial fluid and 100 ml to every 1 L of cavity fluid. Double these quantities for every 10° C. above 20° C. ambient temperature)

TABLE II
Standard case

| | Procedure | Objective | Method |
|---|---|---|---|
| 1. | Position body on | Minimise the restriction | 1. Use body slats across the |
| | the table in a | of flow of fluid | table to elevate body off the |
| | supine position | throughout the body | table top |
| | | | 2. Place a headrest under the |
| | | | head to align it parallel with |
| | | | the table top |
| 2. | Relieve any rigor | Minimise any extra | 1. Flex and rotate joints of |
| | mortis | vascular resistance | extremities, neck and jaw |
| 3. | Flush vascular | 1. Remove the blood | 1. Make up in cold water 12 |
| | system | and toxins from the | litres of the standard |
| | | body tissues | solution noted in Table I. |
| | | 2. Flush system until | 2. Inject solution into an artery |
| | | discharged fluid is | at 60 psi rate of flow 15 |
| | | clear of blood or very | ounces per minute |
| | | diluted | 3. Closed drainage for first 250-500 ml |
| | | | 4. Open drainage for next 3 |
| | | | litres or until discharged |
| | | | fluid is substantially diluted |
| | | | or clear |
| | | | 5. Increase pressure to 60-80 psi |
| | | | and rate of flow |
| | | | remain at 15 ounces per |
| | | | minute |
| | | | 6. Use machine on pulsation |
| | | | mode |
| | | | 7. Occasionally flex and rotate |
| | | | the limbs to encourage fluid |
| | | | circulation and discharge |
| | | | 8. Gently massage areas |
| | | | affected by postmortem |
| | | | lividity |
| | | | 9. NOTE Use a flow of 3-5 |
| | | | opm when injecting directly |
| | | | up the head |
| 4. | Inject fluid into the | To inhibit decomposition | 1. Inject the remaining 8.5 |
| | vascular system | by obtaining maximum | litres into the artery |
| | | distribution and diffusion | 2. Increase pressure to 80-100 psi |
| | | of embalming fluid in all | and rate of flow to |
| | | body tissue | remain at 15 opm |
| | | | 3. Use 3-5 opm when |
| | | | injecting directly up the |
| | | | head |
| | | | 4. Use machine pulsation |
| | | | 5. Use intermittent drainage |
| | | | closed 500 ml and opened |
| | | | 1.5 L cycles |
| | | | 6. Occasionally flex and rotate |
| | | | limbs on the open cycle |
| | | | 7. Lightly massage areas |
| | | | affected by postmortem |
| | | | lividity on the open drainage |
| | | | cycle |
| | | | 8. Continue to inject until the |
| | | | tissues appear “full” of fluid |
| | | | but not swollen |
| | | | 9. Inject last 500 ml under |
| | | | closed drainage to build up |
| | | | pressure within vascular |
| | | | system |
| | | | 10. To retain pressure within |
| | | | the vascular system tie off |
| | | | the artery prior to |
| | | | completely removing the |
| | | | arterial cannula |
| 5. | Cavity aspiration | 1. To remove gases, | 1. Aspirate the thoracic and |
| | | fluids and semi solids | abdominal cavities, heart |
| | | from body cavities | chambers, and intestines, |
| | | and hollow organs | stomach, gallbladder and |
| | | 2. To minimise purge | bladder. |
| | | and leakage from the | 2. Pay particular attention to |
| | | trachea, vaginal canal | thorough perforation of the |
| | | and rectum | intestine and stomach |
| | | | 3. Avoid perforation of the |
| | | | trachea, vaginal canal and |
| | | | rectum |
| 6. | Cavity injection | Inhibit decomposition of | 1. Inject by cavity feed 500 mls |
| | | viscera | of cavity solution noted in |
| | | | Table I over the top of the |
| | | | viscera within the thoracic |
| | | | cavities |
| | | | 2. Inject 500 mls of the |
| | | | concentrate solution over |
| | | | the viscera within the |
| | | | abdominal cavity and |
| | | | directly into the spleen and |
| | | | liver |
| | | | 3. Volume of cavity fluid can |
| | | | be increased depending |
| | | | upon the circumstances |

TABLE III
Post embalm observations in Standard Case

| | | |
|---|---|---|
| 1. | Distribution of arterial | 1. Dilation of superficial blood vessels |
| | fluid | 2. Removal of postmortem discolourations |
| | | 3. Rounding of the finger tips |
| | | 4. Rounding of the lips |
| | | 5. Plumping of the tissues |
| 2. | Joints | Flexible |
| 3. | Skin texture | Soft and natural to touch |
| 4. | Skin colour | Normal to pale complexion |
| 5. | Odour | Nil |
| 6. | Other | No dehydration |

TABLE IV
Renal failure

| | Procedure | Objective | Method |
|---|---|---|---|
| 1. | Position body on | Minimise the restriction | 1. Use body slats across the |
| | the table in a | of flow of fluid | table to elevate body off the |
| | supine position | throughout the body | table top |
| | | | 2. Place a headrest under the |
| | | | head to align it parallel with |
| | | | the table top |
| 2. | Relieve any rigor | Minimise any extra | Flex and rotate joints of |
| | mortis | vascular resistance | extremities, neck and jaw |
| 3. | Flush vascular | 1. Remove the blood, | 1. Make up in cold water 12 |
| | system | nitrogenous waste | litre of the renal solution |
| | | and toxins from the | noted in Table I |
| | | body tissues | 2. Inject solution into an artery |
| | | 2. Flush system until | at 60 psi rate of flow 15 |
| | | discharged fluid is | ounces per minute |
| | | clear of blood or very | 3. Closed drainage for first 250-500 ml |
| | | diluted | 4. Open drainage for next 3 |
| | | | litres or until discharged |
| | | | fluid is substantially diluted |
| | | | or clear |
| | | | 5. Increase pressure to 60-80 psi |
| | | | and rate of flow |
| | | | remain at 15 opm |
| | | | 6. Use machine on pulsation |
| | | | mode |
| | | | 7. Occasionally flex and rotate |
| | | | the limbs to encourage fluid |
| | | | circulation and discharge |
| | | | 8. Gently massage areas |
| | | | affected by postmortem |
| | | | lividity |
| | | | 9. Note Use 3-5 opm when |
| | | | injecting directly up the |
| | | | head |
| 4. | Inject fluid into the | To inhibit decomposition | 1. Inject the remaining 8.5 |
| | vascular system | by obtaining maximum | litres into the artery |
| | | distribution and diffusion | 2. Increase pressure to 80-100 psi |
| | | of embalming fluid in all | and rate of flow to |
| | | body tissue. | remain at 15 opm |
| | | | 3. Use machine pulsation |
| | | | 4. Use intermittent drainage |
| | | | closed 500 ml and opened |
| | | | 1.5 L cycles |
| | | | 5. Occasionally flex and rotate |
| | | | limbs on the open cycle |
| | | | 6. Lightly massage areas |
| | | | affected by postmortem |
| | | | lividity on the open drainage |
| | | | cycle |
| | | | 7. Continue to inject until the |
| | | | tissues appear “full” of fluid |
| | | | but not swollen |
| | | | 8. Inject last 500 ml under |
| | | | closed drainage to build up |
| | | | pressure within vascular |
| | | | system |
| | | | 9. Tie off artery prior to |
| | | | removal of arterial cannula |
| | | | to retain pressure within the |
| | | | vascular system |
| 5. | Cavity aspiration | 1. To remove gases, | 1. Aspirate the thoracic and |
| | | fluids and semi solids | abdominal cavities, heart |
| | | from body cavities | chambers, and intestine, |
| | | and hollow organs | stomach, gallbladder and |
| | | 2. To minimise purge | bladder |
| | | and leakage from the | 2. Pay particular attention to |
| | | trachea, vaginal canal | thorough perforation of the |
| | | and rectum | intestine and stomach |
| | | | 3. Avoid perforation of the |
| | | | trachea, vaginal canal and |
| | | | rectum |
| 6. | Cavity | Inhibit decomposition of | 1. Inject by cavity feed 500 mls |
| | | viscera | of the cavity treatment |
| | | | solution of Table I over the |
| | | | top of the viscera within the |
| | | | thoracic cavities. |
| | | | 2. Inject 500 mls over the |
| | | | viscera within the abdominal |
| | | | cavity and directly into the |
| | | | spleen and liver |
| | | | 3. Volume of cavity fluid can |
| | | | be increased depending |
| | | | upon the circumstances |

TABLE V
Post embalm observations in Renal Failure

| | | |
|---|---|---|
| 1. | Distribution of arterial | 1. Dilation of superficial blood vessels |
| | fluid | 2. Removal of postmortem discolourations |
| | | 3. Rounding of the finger tips |
| | | 4. Rounding of the lips |
| | | 5. Plumping of the tissues |
| 2. | Joints | Flexible |
| 3. | Skin texture | Soft and natural to touch |
| 4. | Skin colour | Normal to pale complexion |
| 5. | Odour | Nil |
| 6. | Other | No dehydration |

TABLE VI
Jaundice

| | Procedure | Objective | Method |
|---|---|---|---|
| 1. | Position body on | Minimise the restriction | 1. Use body slats across the |
| | the table in a | of flow of fluid | table to elevate body off the |
| | supine position | throughout the body | table top |
| | | | 2. Place a headrest under the |
| | | | head to align it parallel with |
| | | | the table top |
| 2. | Relieve any rigor | Minimise any extra | Flex and rotate joints of |
| | mortis | vascular resistance | extremities, neck and jaw |
| 3. | Flush vascular | 1. Remove the blood | 1. Make up in cold water 12 |
| | system | and toxins from the | litres of the jaundice |
| | | body tissues | solution noted in Table I. |
| | | 2. Reduce jaundice | 2. Inject solution into an artery |
| | | discolouration | at 60 psi and rate of flow 10 |
| | | 3. Flush system until | ounces per minute |
| | | discharged fluid is | 3. Closed drainage for first 250-500 ml |
| | | clear of blood or very | 4. Open drainage for next 3 |
| | | diluted | litres or until discharged |
| | | | fluid is substantially diluted |
| | | | or clear |
| | | | 5. Increase pressure to 60-80 psi |
| | | | and rate of flow |
| | | | remain at 10 opm |
| | | | 6. Use machine on pulsation |
| | | | mode |
| | | | 7. Occasionally flex and rotate |
| | | | the limbs to encourage fluid |
| | | | circulation and discharge |
| | | | 8. Gently massage areas |
| | | | affected by postmortem |
| | | | lividity and jaundice |
| | | | staining. |
| 4. | Inject fluid into the | To inhibit decomposition | 1. Inject the remaining 8.5 |
| | vascular system | by obtaining maximum | litres into the artery |
| | | distribution and diffusion | 2. Increase pressure to 80 psi |
| | | of embalming fluid in all | and rate of flow to 15 opm |
| | | body tissue. | 3. Use machine pulsation |
| | | | 4. Use intermittent drainage |
| | | | closed 250 ml and opened |
| | | | 1.5 L cycles |
| | | | 5. Occasionally flex and rotate |
| | | | limbs on the open drainage |
| | | | cycle |
| | | | 6. Lightly massage areas |
| | | | affected by postmortem |
| | | | lividity and jaundice |
| | | | staining on the open cycle |
| | | | 7. Continue to inject until the |
| | | | tissues appear “full” of fluid |
| | | | but not swollen |
| | | | 8. Inject last 500 ml under |
| | | | closed drainage to build up |
| | | | pressure within vascular |
| | | | system |
| | | | 9. Tie off artery prior to |
| | | | removal of arterial cannula |
| | | | to retain pressure within the |
| | | | vascular system |
| 5. | Cavity aspiration | 1. To remove gases, | 1. Aspirate the thoracic and |
| | | fluids and semi solids | abdominal cavities, heart |
| | | from body cavities | chambers, and intestines, |
| | | and hollow organs | stomach, gallbladder and |
| | | 2. To minimise purge | bladder. |
| | | and leakage from the | 2. Pay particular attention to |
| | | trachea, vaginal canal | thorough perforation of the |
| | | and rectum | intestine and stomach |
| | | | 3. Avoid perforation of the |
| | | | trachea, vaginal canal and |
| | | | rectum |
| 6. | Cavity injection | Inhibit decomposition of | 1. Inject by cavity feed 500 mls |
| | | viscera | of the cavity treatment |
| | | | solution of Table I over the |
| | | | top of the viscera within the |
| | | | thoracic cavities. |
| | | | 2. Inject 500 mls over the |
| | | | viscera within the abdominal |
| | | | cavity and directly into the |
| | | | spleen and liver |
| | | | 3. Volume of cavity fluid can |
| | | | be increased depending |
| | | | upon the circumstances |

TABLE VII
Post embalm observations in Jaundice

| | | |
|---|---|---|
| 1. | Distribution of arterial | 1. Dilation of superficial blood vessels |
| | fluid | 2. Removal of postmortem discolourations |
| | | 3. Noticeable (50-75%) removal of jaundice |
| | | discolouration |
| | | 4. Rounding of the finger tips |
| | | 5. Rounding of the lips |
| | | 6. Plumping of the tissues |
| 2. | Joints | Flexible |
| 3. | Skin texture | Soft and natural to touch |
| 4. | Skin colour | Substantial reduction in jaundice |
| | | discolouration |
| 5. | Odour | Nil |
| 6. | Other | No dehydration, no biliverdin |

TABLE VIII
Oedematous

| | Procedure | Objective | Method |
|---|---|---|---|
| 1. | Position body on | Minimise the restriction | 1. Use body slats across the |
| | the table in a | of flow of fluid | table to elevate body off the |
| | supine position | throughout the body | table top |
| | | | 2. Place a head bock under |
| | | | the head to align it parallel |
| | | | with the table top |
| | | | 3. Elevate the legs if affected |
| 2. | Relieve any rigor | Minimise any extra | Flex and rotate joints of |
| | mortis | vascular resistance | extremities, neck and jaw |
| 3. | Flush vascular | 1. Remove the blood, | 1. Makeup in cold water 12 |
| | system | nitrogenous waste | litre of the oedema solution |
| | | and toxins from the | in Table I and 40% Glyoxal |
| | | body tissues | and Sodium Acetate Buffer |
| | | 2. Flush system until | Solution |
| | | discharged fluid is | 2. Inject the solution into an |
| | | clear of blood or very | artery at 60 psi and rate of |
| | | diluted | flow 10 ounces per minute |
| | | 3. Remove some of the | 3. Closed drainage for first 250-500 ml |
| | | oedematous fluid | 4. Open drainage for next 3 |
| | | | litres or until discharge |
| | | | bloody fluid is substantially |
| | | | diluted or clear |
| | | | 5. Increase pressure to 60-80 psi |
| | | | and rate of flow to 15 |
| | | | opm |
| | | | 6. Use machine on pulsation |
| | | | mode |
| | | | 7. Frequently flex and rotate |
| | | | the limbs to encourage fluid |
| | | | circulation and discharge |
| | | | 8. Gently massage areas |
| | | | affected by postmortem |
| | | | lividity |
| 4. | Inject fluid into the | To inhibit decomposition | 1. Inject the remaining 8.5 |
| | vascular system | by obtaining maximum | litres into the vascular |
| | | distribution and diffusion | system |
| | | of embalming fluid in all | 2. Increase pressure to 80-100 psi |
| | | body tissue. | and rate of flow |
| | | | remain at 15 opm |
| | | | 3. Use machine pulsation |
| | | | 4. Use intermittent drainage |
| | | | closed 250 ml and open 1.5 L |
| | | | cycles |
| | | | 5. Frequently flex and rotate |
| | | | limbs on the open cycle |
| | | | 6. Massage areas affected by |
| | | | postmortem lividity on the |
| | | | open cycle |
| | | | 7. Continue to inject until the |
| | | | tissues appear “full” of fluid |
| | | | but not swollen |
| | | | 8. Inject the last 250 ml under |
| | | | closed drainage to build up |
| | | | pressure within vascular |
| | | | system |
| | | | 9. Tie off artery prior to |
| | | | removal of arterial cannula |
| | | | to retain pressure within the |
| | | | vascular system |
| 5. | Cavity aspiration | 1. To remove gases, | 1. Aspirate the thoracic and |
| | | fluids and semi solids | abdominal cavities, heart |
| | | from body cavities | chambers, and intestines, |
| | | and hollow organs | stomach, gallbladder and |
| | | 2. To minimise purge | bladder. |
| | | and leakage from the | 2. Pay particular attention to |
| | | trachea, vaginal canal | thoroughly perforation of the |
| | | and rectum | intestine and stomach |
| | | | 3. Avoid perforation of the |
| | | | trachea, vaginal canal and |
| | | | rectum |
| 6. | Cavity injection | Inhibit decomposition of | 1. Inject by cavity feed 500 mls |
| | | viscera | of the cavity treatment |
| | | | solution of Table I and 40% |
| | | | Glyoxal and Sodium |
| | | | Acetate Buffer Solution over |
| | | | the top of the viscera within |
| | | | the thoracic cavities. |
| | | | 2. Inject 500 mls of the cavity |
| | | | treatment solution of Table I |
| | | | over the viscera within the |
| | | | abdominal cavity and |
| | | | directly into the spleen and |
| | | | liver |
| | | | 3. Volume of cavity fluid can |
| | | | be increased depending |
| | | | upon the circumstances |

TABLE IX
Post embalm observations in Oedematous

| | | |
|---|---|---|
| 1. | Distribution of arterial | 1. Dilation of superficial blood vessels |
| | fluid | 2. Removal of postmortem discolourations |
| | | 3. Rounding of the finger tips |
| | | 4. Rounding of the lips |
| | | 5. Plumping of the tissues |
| 2. | Joints | Flexible |
| 3. | Skin texture | Slightly firm and dry |
| 4. | Skin colour | Pale |
| 5. | Odour | Nil |
| 6. | Oedematous areas | Reduction in fluid mass |

TABLE X
Presentation only

| | Procedure | Objective | Method |
|---|---|---|---|
| 1. | Position | Minimise the | 1. Use body slats across the |
| | body on | restriction of flow | table to elevate body off |
| | the table | of fluid throughout | the table top |
| | in a supine | the body | 2. Place a headrest under the |
| | position | | head to align it parallel with |
| | | | the table top |
| 2. | Relieve | Minimise any extra | Flex and rotate joints of |
| | any rigor | vascular resistance | extremities, neck and jaw |
| | mortis | | |
| 3. | Flush | 1. Remove the blood | 1. Make up in cold water 6 |
| | vascular | and toxins from the | litres of the standard |
| | system | body tissues | solution noted in Table I. |
| | | 2. Flush system until | 2. Inject solution into an artery |
| | | discharged fluid is | at 60 psi rate of flow 15 |
| | | clear of blood or very | ounces per minute |
| | | diluted | 3. Closed drainage for first |
| | | 3. Provide minimal | 250-500 ml |
| | | retardation of | 4. Open drainage for next 3 |
| | | decomposition | litres or until discharged |
| | | | fluid is substantially diluted |
| | | | or clear |
| | | | 5. Increase pressure to 70-80 psi |
| | | | and rate of flow |
| | | | remain at 15 opm |
| | | | 6. Use machine on pulsation |
| | | | mode |
| | | | 7. Occasionally flex and |
| | | | rotate the limbs to |
| | | | encourage fluid circulation |
| | | | and discharge |
| | | | 8. Gently massage areas |
| | | | affected by postmortem |
| | | | lividity |
| | | | 9. Use intermittent drainage |
| | | | closed 250 ml and open |
| | | | 1.5 L cycles for remaining |
| | | | fluid |
| | | | 10. NOTE Use 3-5 opm when |
| | | | injecting directly up the |
| | | | head |
| 4. | Cavity | 1. To remove gases, | 1. Aspirate the thoracic and |
| | aspiration | fluids and semi solids | abdominal cavities, heart |
| | | from body cavities | chambers, and intestines, |
| | | and hollow organs | stomach, gallbladder and |
| | | 2. To minimise purge | bladder. |
| | | and leakage from the | 2. Pay particular attention to |
| | | trachea, vaginal canal | thorough perforation of the |
| | | and rectum | intestine and stomach |
| | | | 3. Avoid perforation of the |
| | | | trachea, vaginal canal and |
| | | | rectum |
| 5. | Cavity | Inhibit decomposition | 1. Inject by cavity feed 500 mls |
| | injection | of viscera | of cavity solution noted in |
| | | | Table I over the top of the |
| | | | viscera within the thoracic |
| | | | cavities |
| | | | 2. Inject 500 mls of the |
| | | | concentrate solution over |
| | | | the viscera within the |
| | | | abdominal cavity and |
| | | | directly into the spleen and |
| | | | liver |
| | | | 3. Volume of cavity fluid can |
| | | | be increased depending |
| | | | upon the circumstances |

TABLE XI
Post embalm observations in Presentation only

| | | |
|---|---|---|
| 1. | Distribution of | 1. Minimal dilation of superficial blood vessels |
| | arterial fluid | 2. Removal of postmortem discolourations |
| | | 3. Some rounding of the finger tips |
| | | 4. Rounding of the lips |
| | | 5. Minimal plumping of the tissues |
| 2. | Joints | Flexible |
| 3. | Skin texture | Soft and natural to touch |
| 4. | Skin colour | Normal to pale complexion |
| 5. | Odour | Nil |
| 6. | Other | No dehydration |

TABLE XII
Posted cases

| | Procedure | Objective | Method |
|---|---|---|---|
| 1. | Arterial injection | To maximise distribution | Use six point injection using |
| | | and diffusion of sanitiser | previously described practices |
| 2. | Cavity treatment | 1. To maximise cut | 1. Remove viscera from plastic |
| | | surface area of | bag |
| | | viscera to enable fluid | 2. Dissect the organs into 20 mm |
| | | absorption | thick slices to increase |
| | | 2. Distribute and diffuse | the surface area exposed to |
| | | with Mortech | the solution and enable |
| | | Supreme 2 in 1 Cavity | maximum diffusion of the |
| | | fluid | cavity fluid |
| | | | 3. Rinse viscera to remove |
| | | | any excess waste products |
| | | | 4. Soak viscera in 1 litre of |
| | | | cavity treatment solution of |
| | | | Table I and 40% Glyoxal |
| | | | and Sodium Acetate Buffer |
| | | | Solution |
| 3. | Cavity wet pack | Return the viscera to the | 1. Place viscera into a plastic |
| | | body in a wet solution | bag and add 500 ml cavity |
| | | | fluid |
| | | | 2. Remove a much air as |
| | | | possible from the bag and |
| | | | tie it off to prevent leakage |
| | | | 3. Place the bag of viscera into |
| | | | the body cavity |
| | | | 4. Restore postmortem |
| | | | incisions as per normal |
| | | | procedures |
| 4. | Cavity dry pack | Return the viscera to the | 1. Place the viscera that has |
| | with a mixture of | body | been soaked in cavity fluid, |
| | medium and coarse | | back into the body cavity in |
| | Sodium Chloride | | thin layers |
| | granules | | 2. Sprinkle a generous layer of |
| | | | a mixture of medium and |
| | | | coarse Sodium Chloride |
| | | | granules between each |
| | | | layer of viscera |
| | | | 3. Cover both surfaces of the |
| | | | sternum with a generous |
| | | | layer of a mixture of |
| | | | medium and coarse Sodium |
| | | | Chloride granules |
| | | | 4. Restore postmortem |
| | | | incisions as per normal |
| | | | practise |
| 5. | Post embalm hypo- | To maximise diffusion of | Hypodermically inject any |
| | injection | sanitiser in the more | areas that show evidence of or |
| | | vascular organs of the | are suspected to lack arterial |
| | | body and localised areas | diffusion with Chlorine Dioxide |
| | | of tissues that require | in Aqueous Solution |
| | | additional fluid | |
| 6. | Additional | To dehydrate and | 1. Reflect the skin and soft |
| | treatment with a | sanitise soft tissue mass with | tissue flaps from the |
| | mixture of medium | cavity compound | thoracic cage |
| | and coarse Sodium | | 2. Make long cuts 20 ml apart |
| | Chloride granules | | through the breast and soft |
| | | | tissues |
| | | | 3. Sprinkle a generous layer of |
| | | | a mixture of medium and |
| | | | coarse Sodium Chloride |
| | | | granules into the open cut |
| | | | surfaces |
| | | | 4. Cover both surfaces of the |
| | | | sternum with a generous |
| | | | layer of a mixture of |
| | | | medium and coarse Sodium |
| | | | Chloride granules |
| | | | 5. Restore postmortem |
| | | | incisions as per normal |

TABLE XIII
Additional treatment for cases that are required to be held beyond 5
days to a maximum of 21 days

| | Procedure | Objective | Method |
|---|---|---|---|
| 1. | Add 40% Glyoxal | To extend the period of | Add 180 mls of 40% Glyoxal |
| | and Sodium | retardation of microbial | and Sodium Acetate Buffer |
| | Acetate Buffer | action to 21 days | Solution to every 4 litres of |
| | Solution to arterial | | arterial solution or 100 mls to |
| | solution | | each litre Chlorine Dioxide in |
| | | | Aqueous Solution |
| 2. | Increasing the | Further assurance for | Double the recommended |
| | amount of 40% | microbial retardation in | amount of 40% Glyoxal and |
| | Glyoxal and | temperatures above 30° C. | Sodium Acetate Buffer |
| | Sodium Acetate | | Solution for every 10° C. above |
| | Buffer Solution for | | 30° C. |
| | ambient | | |
| | temperatures | | |
| | above 30° | | |
| 3. | Arterial injection | To maximise distribution | Use six point injection of |
| | | and diffusion of sanitiser | standard fluid set forth in Table |
| | | | I by using previously described |
| | | | practises |
| 4. | Cavity fluid | To distribute and diffuse | 1. Inject by cavity feed |
| | | to the intestinal wall and | 500 mls of the cavity |
| | | contents. | treatment solution of Table |
| | | | I over the top of the viscera |
| | | | within the thoracic cavities. |
| | | | 2. Inject 500 mls of the |
| | | | Chlorine Dioxide in |
| | | | Aqueous Solution 500 ppm |
| | | | of Table I over the viscera |
| | | | within the abdominal cavity |
| | | | and directly into the spleen |
| | | | and liver |
| | | | 3. Volume of Chlorine Dioxide |
| | | | in Aqueous Solution can be |
| | | | increased depending upon |
| | | | the circumstances |
| 5. | Post embalm hypo- | To maximise diffusion of | 1. Inject directly into the lobes |
| | injection | sanitiser in the more | of the liver and spleen with |
| | | vascular organs of the | a 100 ml syringe and 8 inch |
| | | body and localised areas | hypodermic or Erebus |
| | | of tissues that require | needle. Fan out the injection |
| | | additional fluid. | angles from the same entry |
| | | | point |
| | | | 2. Hypodermically inject any |
| | | | areas that show or are |
| | | | suspected of lacking arterial |
| | | | diffusion |
| | | | 3. Close off the injection points |
| | | | with a trocar button |

TABLE XIV
In the case of any deterioration of the condition of the body the
following procedures can be employed

| | Procedure | Objective | Method |
|---|---|---|---|
| 1. | Re-embalm with a | To arrest any | 1. In the case of generalised |
| | Chlorine Dioxide in | further | deterioration of the body, |
| | Aqueous Solution | decomposition | raise the same vessels |
| | and 40% Glyoxal | of the tissues. | used in the initial injection |
| | and Sodium | | procedure and repeat the |
| | Acetate Buffer | | process using Chlorine |
| | Solution | | Dioxide in Aqueous Solution |
| | | | 500 ppm and 40% Glyoxal |
| | | | and Sodium Acetate Buffer |
| | | | Solution |
| | | | 2. In cases where the |
| | | | deterioration is more |
| | | | localised either raise the |
| | | | appropriate vessels that |
| | | | supply the particular region |
| | | | or hypodermically inject |
| | | | superficially and deep into |
| | | | the affected tissues |
| 2. | Post embalm | Mask | Apply cosmetics over the area |
| | discolourations | discolouration | until concealed. Use the |
| | (grey hue) | with cosmetics | colour wheel to select the |
| | | | appropriate neutralising |
| | | | colour. |

TABLE XV
Trouble shooting tips

| | Problem | Possible cause | Remedy |
|---|---|---|---|
| 1. | Excessive fluid | Obstructed drainage | 1. Clear any postmortem |
| | to localised | caused by drainage | clot from the drainage |
| | areas such as | instrument or other type | instrument |
| | the shoulder | of intra vascular | 2. Retract the drainage |
| | and back of the | obstruction | tube and reinsert a |
| | neck | | tube of smaller |
| | | | diameter |
| | | | 3. Remove drainage tube |
| | | | and use forceps or |
| | | | alternative drainage |
| | | | instrument |
| | | | 4. Raise alternative |
| | | | drainage point |
| | | | 5. Check that the head is |
| | | | position in line with the |
| | | | body |
| 2. | Pale gray hue | This discolouration is | 1. Do not over inject |
| | over localised | due to the | 2. Do not over massage |
| | areas of the | deoxygenation of the | 3. Check that the head is |
| | body | blood due to a chemical | position in line with the |
| | | reaction and is not an | body |
| | | indication of | 4. Conceal with |
| | | decomposition and there | cosmetics |
| | | will be no odour or | |
| | | separation of the dermal | |
| | | layers. Any sign of | |
| | | colour change is likely to | |
| | | be instant and will not | |
| | | increase or decrease in | |
| | | depth over time. The | |
| | | affected areas can be | |
| | | easily concealed with | |
| | | cosmetics. | |

Having described my invention in such a way to enable those skilled in the art to practice the invention and having described the presently preferred embodiments and best mode thereof,

I Claim:

1. A method of inhibiting the rate of decomposition of human remains comprising embalming the remains with Chlorine Dioxide in Aqueous Solution.
